(19) United States
(12) Patent Application Publication
(10) Pub. No.: US 2025/0029520 A1
(43) Pub. Date: Jan. 23, 2025

(54) Heightened-Visibility Street Address Signage Incorporated with Impossible-to-Miss Distress Beacon

(71) Applicants: David Graham, Naugatuck, CT (US); MaryAnne Graham, Naugatuck, CT (US)

(72) Inventors: David Graham, Naugatuck, CT (US); MaryAnne Graham, Naugatuck, CT (US)

(21) Appl. No.: 18/586,291

(22) Filed: Feb. 23, 2024

Related U.S. Application Data
(60) Provisional application No. 63/527,388, filed on Jul. 18, 2023.

(51) Int. Cl. G09F 19/12; G08B 5/36; G09F 9/30

(52) U.S. Cl. CPC G09F 19/12; G08B 5/36; G09F 9/30

(57) ABSTRACT

Proposed is a street address signage device, for commercial or residential use, wherein said street address signage device is configured to be affixed to a building, or another structure or an auxiliary edifice on a residence or property, for enhanced wayfinding purposes. The primary purpose of the device is to clearly and brilliantly display a street address during all lighting and weather conditions to passing traffic or anyone within the vicinity. The secondary purpose is to alert and/or advertise with excessive/aggressive means, to anyone within eyesight of said residence or property, a heightened-need beacon or distress symbol or specialized display. In a most preferred embodiment the heightened need is an emergency situation. In said most preferred embodiment said primary purpose comprises displaying numbers on a lighted front screen and said secondary purpose comprises flashing or strobing bright lights.

### CROSS-REFERENCE TO RELATED APPLICATIONS

This Non-Provisional Patent Application claims priority of U.S. provisional patent application Ser. No. 63/527,388, filed on Jul. 18, 2023, titled “Illuminated Signage Apparatus for Real Property Identification and Method for Aiding Emergency Response”, with David Graham and MaryAnne Graham as the joint inventors of the above provisional patent application.

### TECHNICAL FIELD OF THE INVENTION

The following disclosure relates generally to various fields of mechanical engineering and electrical engineering and their joint application to augmenting and accelerating the ability of persons or an entity to identify a property, driveway, and/or other location or location-specific data point, in preferred embodiments a street address, such that people seeking said property/location can pinpoint said location immediately upon being within eyesight of it during normal situations, and such that anyone within the general vicinity of said location will be visibly led or lured to said location during emergency situations that are taking place near or within said location.

### BACKGROUND OF THE INVENTION

In general, houses and other buildings residing in series along a road are marked by address labels or plaques that are more-or-less visible from the road. From the point of view of a person in a vehicle attempting to locate the house or building, a least advantageous mode for fulfilling this obligation incorporates unlit numerals or an unlit plaque affixed to the house/building's exterior surface, in which instance even a person with good vision traveling along the road at a modest speed in full daylight will have to concentrate most of their attention on the house/building fronts, while being distracted from the road, and might even slow down frequently in order to ascertain to certainty a target address once in the locale.

From the point of view of that person driving down a road attempting to locate a specific house or building, more advantageous prior art modes for fulfilling the obligation include a designated marking/display at the juncture of the house/building's property where it meets the road, such as for instance on a mailbox next to a driveway or simply a stand-alone sign or sign-post, wherein the address label can be vertically inscribed or affixed on or along the sign or sign-post, or placed on a display stand at the top of or cantilevered from or affixed to the surface of any other pre-existing or customized roadside structure.

However, it is well known to persons that spend a considerable amount of their time locating addresses that this system is piecemeal in the majority of geographical areas and in some areas completely non-functional, especially at night or in inclement weather, and these drawbacks are exacerbated in areas that lack data/cell service that would normally assist said persons to arrive at the general vicinity of the address before diverting the majority of their attention to focusing on passing address signs, near the road as well as far from the road, usually nondescript during daylight and also usually nearly invisible at night.

During the best of prior-art scenarios, GPS or a maps app would take a driver to the area and then they would immediately observe a brand-new address label, brightly painted with high-contrast colors and lit with a light such as a spotlight. But during the worst of scenarios, GPS has long ceased to be of any assistance due to the driver being in a cell/data blackout area, the driver is relying on maps and street-signs, and it is too dark to quickly, or even slowly, make out the passing address markings. For a delivery driver or service provider not responding to an emergency, this can lead to delays and frustration, and in a worst case it can result in the complete failure to locate a property before the day/shift is over, and having to re-attempt the delivery/service at another time.

For an emergency service provider, such as for example EMS, fire department, and police, responding to a dispatch order wherein no other location data is available but the street address number itself, this scenario could be dire, wherein each wasted minute is potentially irremediably damaging to the health/safety of the person(s) needing assistance and/or their property, if not completely catastrophic, and, as should well be appreciated to anyone, but more so to drivers adjacent to these situations, especially to those who have experienced the worst scenarios, no expense should be spared to insure that the driver knows exactly where to go, can go there at full speed, and then halt the vehicle at the scene without a single second's delay.

### DISCUSSION OF THE PRIOR ART

Various prior-art approaches have been published in attempts to solve the aforementioned problems, and the most relevant prior art examples available to the Applicant are summarily discussed herein, as follows.

U.S. Pat. No. 4,686,505 A to Curtis Vanderburg teaches an emergency lighting system activated by a homeowner. The device has a transparent portion with street address numbers illuminated from behind during normal situations, and when an emergency is in effect, a strobe light is flashed. The street address number portion is encased in a first portion of the device and the strobe light is encased in a second portion of the device. The switch to activate the strobe light is located on the device housing.

U.S. Pat. No. 6,901,688 B1 to Thomas King teaches a house address number signage device with two or more lights. The lights turn on when the ambient light level drops (i.e. near sunset) and off when the ambient light level rises (i.e. sunrise), and it discusses a provision/embodiment wherein the lights can back-light and/or side-light the address numbers. Further, during emergencies the lights, or at least some of them, can be made to flash. Like Vanderburg, the switch to activate the emergency mode is attached to the device housing.

U.S. Pat. No. 6,401,373 B1 to Clifford Sexton teaches an illuminated address display device with interchangeable number plates whose numbers are voids to allow light to emanate through the plate in the shape of the numbers. A light located behind the plates provides the light and when assembled by the property owner and the light is turned on (in response to an ambient light sensor), the address is made visible during darker hours. Another light, such as a red light, can be activated by a switch to alert passersby or emergency personnel of a medical situation.

U.S. Pat. No. 4,855,723 A to Marlene Fritz teaches an alarm unit with numeral-shaped arrays of LED's that can be used to create an illuminated street address display. During emergency situations an audible siren and/or strobe light are/is can be energized to attract the notice of neighbors and emergency personnel. The alarm mode can be activated and deactivated by a remote control which can also be used to select the brilliance level of the address display.

U.S. Pat. No. 5,521,578 to Ivan Delvalle teaches a combination address display device and doorbell control assembly, wherein the address display portion contains an illuminated street address (numbers and street name) that can be made to flash during emergency situations by manual activation by a homeowner. The numbers are on a sheet and can be backlit to achieve the stated purposes.

U.S. Pat. No. 4,993,058 A to Edward McMinn et al. teaches an illuminated house light display having numbers on a generally translucent plate that is backlit by conventional incandescent bulbs. In response to a person inside the house dialing “9-1-1” on a landline telephone or in response to a person initiating a manual alarm switch, a bright light inside the address display emits a strobe to intermittently brighten the display to assist with discerning the device at night.

Published US Patent Application No. 20160071400 A to Nadar Nowzari teaches a personal incident alert for alerting aid responders to guide them to a residence. The device can be remotely activated to provide lighting effects such as a flashing white light or alternating white and red lights. The remote activation means can be worn by the user. In an embodiment, the device can include an illuminated house street number sign which can be modified to incorporate LED lights that can alternate colors or can change to display a word like “help” in place of the house number. Many modes are included such as quickly blinking the emergency light and providing an audible siren.

US Published Patent Application No. 20210183278 A1 to Joseph Lai teaches a smart address sign means wherein the hardware and software of the device are capable of illuminating not only an address number (and for instance the street name, town, or name of resident) but also messages for visitors, the messages being remotely entered by an input device. The overall device is a general-purpose platform for serving as an intruder alarm, smoke detector, weather station, camera, and automatic door opener. Provision is included, among the many provisions discussed within the disclosure, for detecting emergencies (i.e. of the inhabitant, such as by sensing body temperature or other vital sign monitoring via a worn transceiver), and sending visual/radio beacons and homing signals to help visitors locate the address. For instance, in one mode the address numbers can be replaced with a “SOS” sign during emergencies.

U.S. Pat. No. 10,878,730 B2 to Royce Newcomb teaches an illuminated address sign that can be provided with a light sensor, and a GPS system which can be used to detect the entry of a first responder within a predetermined area and start signaling a red light source to signal them. The device includes an illuminated address plaque with provisions for green, white, and red lights. It can signal to a delivery personnel using the green light, to emergency assistance personnel with the red light, and the white light can be stable. Provision is discussed for flashing the lights. The modes can be triggered remotely from inside the house.

U.S. Pat. No. 7,356,260 B2 to Billie Jo Seifert teaches a residential signal beacon having an illuminated or reflective display for the resident's address (i.e. numerical) with a selectively activatable beacon for drawing attention to the address, including the provision of a blue light for signaling to the police, and other colors for other personnel/purposes. The beacon sits atop the signage portion and can strobe, rotate, or change colors.

### BRIEF SUMMARY OF THE INVENTION

In light of the preceding discussion and the perceived deficiencies in the prior art, it is believed by Applicant at this time that there is a need for a fail-safe method and system that allows immediate confirmation of each passing address a driver passes as the addresses are passed, even in the worst visibility situations, and not only that, one where every driver can always count on being able to read every passing address while traveling at full speed. This capability would reduce the costs of delivery and transportation services in general, and could under the best implementation, with even more internal and external features for attracting attention to a single address during times of distress (said single address being the driver's target and the driver knowing that the single address will be attracting attention to itself), lead to a material reduction in response times in situations where the occupant of an property or residence (i.e. an address) has placed a distress call or activated some other type of distress request to a public or municipal emergency service provider.

It is a first objective of the invention to provide a street address signage device, for commercial or residential use, wherein said street address signage device is configured to be affixed to a building, or another structure or an auxiliary edifice on a residence or property, for enhanced wayfinding purposes. The device is primarily used to clearly and brilliantly display a street address during all lighting and weather conditions, such that no matter the circumstances, passing drivers can immediately make out the street address number, and/or other address-relevant data such as the street name, resident's name, etc.

It is another objective of the invention to use the same street address signage device that is being used to display a street address, to also alert and/or advertise, with excessive/aggressive means such as a beacon light that flashes, strobes, moves, etc., invasively catching the attention of anyone within eyesight of said residence or property, in order to inform them and the general locale of an emergency situation, the expectation of a delivery or other service, or any other scenario for which such attention might be sought. In a most preferred embodiment the heightened need is an emergency situation such as a medical event, burglary, etc., and the aggressive advertisement means is a flashing light that is bright enough to be unmistakable and unignorable, even from a considerable distance.

### BRIEF DESCRIPTION OF THE DRAWINGS

The accompanying figures, which are incorporated herein, form part of the specification and illustrate embodiments of the present invention. Together with the detailed description of the preferred embodiments, the figures further explain the principles of the present invention and enable a person skilled in the relevant arts to make and use the invention.

FIG. 1 is a front view illustrating a preferred embodiment of a heightened-visibility street address signage device according to the present invention.

FIG. 2 is a front perspective view of the address signage device of FIG. 1.

FIG. 3 is another front view of the preferred embodiment of the heightened-visibility street address signage device illustrating a normal or typical mode of the display portion of the device during a non-emergency state.

FIG. 4 is another front view of the preferred embodiment of the heightened-visibility street address signage device illustrating an emergency/alert mode of the display portion of the device during an emergency/alert state.

FIG. 5 is another front view of the preferred embodiment with the display screen removed (but with the bezel still in place) to illustrate the internal electronic hardware that enables the functioning of the street address signage during the various modes detailed herein.

FIG. 6 is a front cross-sectional view of a secondary embodiment of the heightened-visibility street address signage device with the display screen and bezel removed to illustrate the internal functioning (electronic) parts of said secondary embodiment.

FIG. 7 is a front perspective view of said secondary embodiment of the heightened-visibility street address signage device, with said display screen and bezel in place, illustrating the external functional parts of said secondary embodiment. FIGS. 6 and 7 jointly illustrate the same embodiment and share reference numerals (arrows/leaders) when appropriate to assist a reader in quickly apprehending the embodiment.

### DETAILED DESCRIPTION OF THE PREFERRED EMBODIMENTS

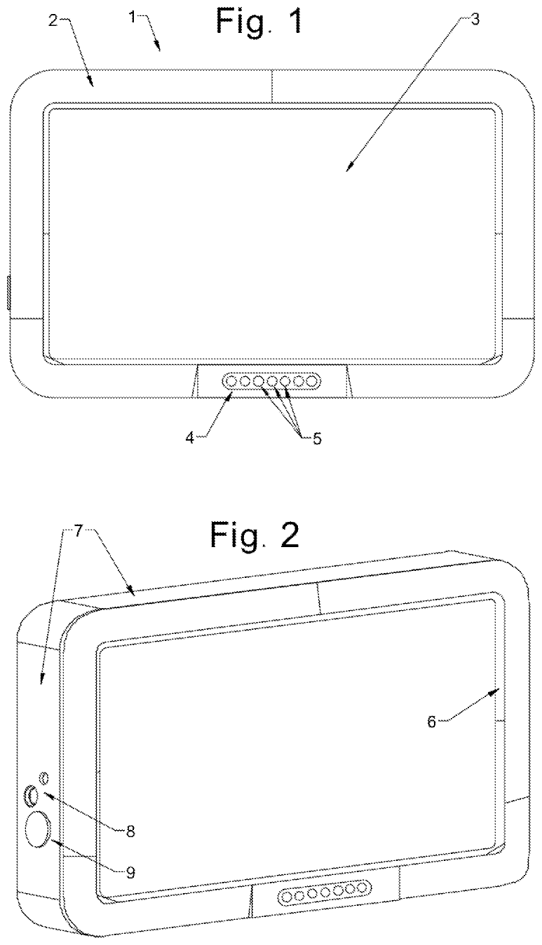

During the discussion herein the embodiments of the proposed invention are presented with reference to FIGS. 1-7, wherein like reference numerals refer to like elements or features throughout.

Initially referring to FIG. 1, the address signage device 1 according to the present invention is generally shown in a front view, as it would be seen by someone seeing it from its front and, more importantly, from the street. A display screen 3 is mounted for presenting maximum visibility and can be fastened in a weatherproof manner in well-known fashion using a bezel 2 or similar means.

Referring simultaneously to FIGS. 1, 2, and 5, a housing generally consists of side walls 7 and a back wall 11 that create a hollow space for situating the internal elements, described later, of the proposed embodiments. Referring now to FIG. 2, once the display screen 3, which should itself be weatherproof on at least its front surface (that shown in FIG. 2), has been secured to the side walls 7 using, for instance, the bezel 2, the hollow space is substantially enclosed and can be sealed and made weatherproof via well-known methods and mechanisms. This can include glazing or sealing means generally referred to as reference numeral 6 in FIG. 2, the manner whereby the glazing supports the display screen not being germane to the present discussion, as the various manners for incorporating a display screen on the front of a housing are very well known in the art. Therefore, the inner surface of the bezel and the seals, gaskets, and glazings that could be part of this scheme are generally referred to with the reference numeral 6 in FIG. 2, and will not be discussed again herein.

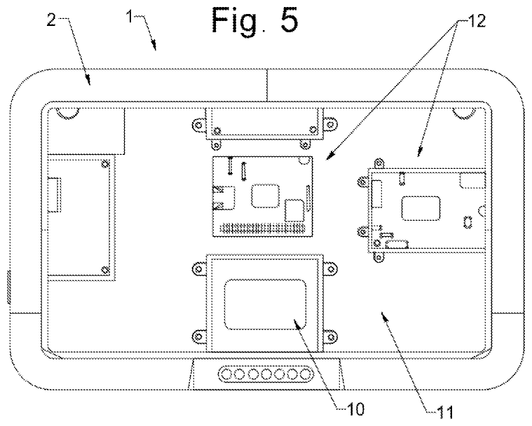

By other well-known means the bezel can be attached to the side walls 7 and the side walls 7 can be attached to the back wall 11 in a manner that keeps water, debris, insects, etc. permanently locked out of the device 1, which (referring to FIG. 5) allows the utilization of inexpensive electronic elements 12 and a battery 10 to energize and control the working parts (display screen 3 and beacon 4) of the preferred embodiment without being damaged or worn. This is particularly important because the device 1 is meant to be used almost exclusively outdoors. For these reasons the bezel 2, side walls 7, and back wall 11 should be comprised of any plastic, metal, or glass substances that are in themselves rigid, durable, and waterproof, with polymer (i.e. plastic or resin) materials probably being the most preferred, as is well known to be optimal for outdoor electronic devices. The device may take any size or shape as long as the display screen 3 is large enough to be seen at a desired distance.

In preferred embodiments the display screen 3 can be back-lit, front-lit, side-lit (such as for instance using light-guides), rear-projection, LED, OLED, or any other type of display means known to be useful in such situations, and the choice of one over the other should be based on cost, energy-consumption, desired brilliance or brightness, contrast, and clarity, wherein the selection of one type of display means over another is an engineering concern that only requires ordinary skill in the art.

Referring again to FIG. 1, the device 1 further comprises a beacon 4 that is intended to emit at least one extraordinarily bright light, wherein said emission is accomplished via at least one light source 5 wherein in the embodiment shown in the figures, although this should not be seen as limiting as many other embodiments are obvious to ordinary practitioners in the art at the time of filing, the at least one light source is depicted as a horizontal array of light sources 5. The at least one extraordinarily bright light emitted from the beacon 4 should have a brilliance capable of being not only seen, but un-ignorable and even distracting, to anyone within the vicinity of the device 1. It should also, in a preferred embodiment, be bright enough such that the surroundings of the device, such as a yard, driveway, street, trees, etc., are themselves lit up when the beacon 4 is activated. In this way, the beacon 4 draws all human attention to the device 1 during, as will be discussed later, an emergency/alert mode of the device.

The beacon 4 could emit a constant light, an intermittent flashing light, a strobe-effect light, patterns of lights and colors in coordination, combinations of flashing effects and colors and patterns, simulated movement (i.e. the light sources 5 are controlled to make it look like a single light is moving back and forth), whatever is determined to be most advantageous or aesthetically pleasing for the purpose it is addressing at any given moment or in any given place of use. These ideas are also well known in the relevant arts and more discussion is not needed here.

Referring to FIG. 2, a push-button 9 can be included somewhere (anywhere considered most useful or ergonomic) on the housing and, as shown in the embodiment of FIGS. 1-2, it can be located on a side wall 7. The push-button 9 can be part of a manual input suite that also includes remote (manual or other) inputs such as, for example: 1) push-button or panic-button means inside the house; 2) worn triggers such as medic alert bracelets or smart-watches; 3) intruder alarms; 4) an occupant of the house dialing 9-1-1; 5) a smart-phone app; 5) a command or push from an emergency service provider or delivery provider's dispatch professional or a credentialed website; the list could continue to describe all the personal and handheld technologies of the world that could communicate with the device wirelessly (directly or over the internet) and although it might be interesting, the reader and public at large knows what this means. The internet-of-things IoT world is expanding year after year and all the things known in one part of that world are useful in many other parts, such that anything that is valuable or useful for combination herein with the wireless capabilities of the signage device 1 should be considered obvious to one of ordinary skill in the arts.

The push-button 9 and remote input suite are used either independently or together to activate and deactivate the various useful modes of the device 1, such as by controlling the display screen 3 and beacon 4 to accomplish whatever is being required of the device at any given time. It should be understood by those skilled in the art that the type of push-button 9 shown (basically a toggle) is not the only type of manual on-housing input that is envisioned as being useful, and its placement on the left side wall 7 in FIG. 2 is arbitrary and should not be seen as limiting. It could be positioned anywhere on the exterior of the device 1 in a place or angle most adequate to permit access by a user but hopefully precluding its being inadvertently pushed during unwanted times.

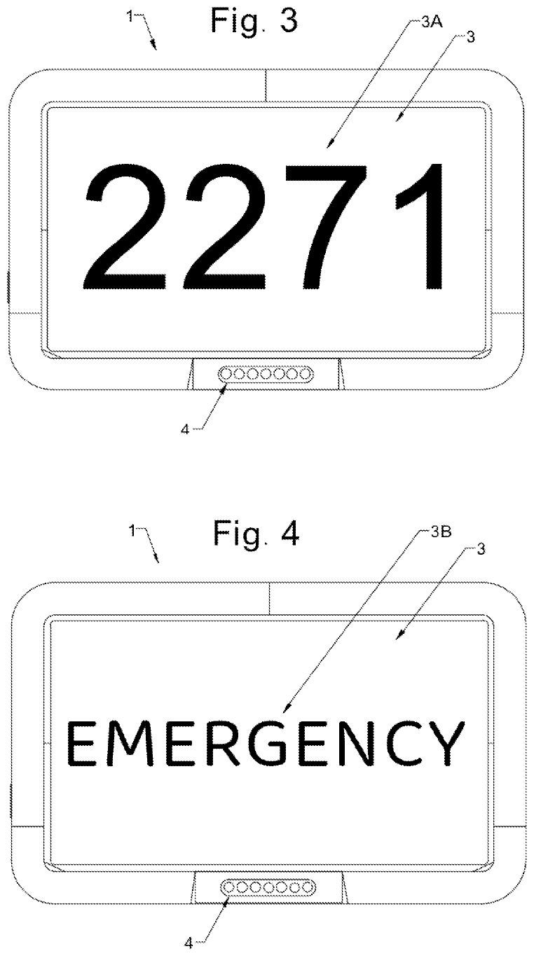

Turning now to FIG. 3, which is a front view similar to FIG. 1 and which again shows the heightened-visibility street address signage device 1 comprising a display screen 3 and the beacon 4. FIG. 3 specifically shows a normal or typical mode which is visible during a non-emergency or non-alert operational state. Importantly, when no other message is to be displayed for emergency/alert reasons, the display screen 3 simply displays the street address number (or alphanumeric string) which is indicated in FIG. 3 as number 3A. Considering that the best mode for manufacturing the preferred embodiment probably but not necessarily involves a digital display, the discussion of how the numbers (in this even the digits “2271” but any number could be displayed) are generated will be omitted since there are various well-known ways of generating them.

Some type of hardware, said hardware also likely running software and/or remotely generated inputs, will convert electricity, from the battery 10 or a (i.e. grid-based) power connection or analogous electrical supply, into the signals and electricity used by the display screen 3 to display whatever the hardware/software makes it generate, and in the instance shown in FIG. 3 it is made to generate a numerical string that is input manually or via some remote means at the time of acquisition by or transition to a new household occupant.

As would be obvious to one of ordinary skill in the art, and especially since the digital display and drivers needed to do so are now inexpensive and widely available, the normal/typical image presented by display screen 3 could also include name or other identifier information of the occupant(s), the street name, a sports team name, a flag, a religious or holiday or peace greeting, or anything really, and the colors of the output digits/characters and the background could be set to assume any colors or color combinations desired by the household occupant. This is to say as well that the primary information (the street address number) should be relatively static in a general sense, even though other things could be going on, even dynamically, across, around, and/or behind the numbers. The important thing is that the numbers stand starkly out for passersby such that they instantly and correctly behold and ascertain the numerical information, since this is usually what they will be looking for. It is noted in passing that the beacon 4 in the normal/typical mode is unlit and unnoticeable.

On the other hand, and with reference now to FIG. 4, the normal/typical mode of the display screen 3 of the device 1 is not always displayed. The device 1 can be placed into a secondary, emergency/alert mode during an emergency/alert state. FIG. 4 is the same view as FIG. 3 but the display screen static non-emergency message 3A has been changed to an emergency or alert message 3B which although it could be anything useful, is not simply a street address number.

Still referring to FIG. 4, the emergency/alert message 3B could simply be the name or logo of a delivery agency, a food takeout chain, a ridesharing or taxi service, etc., with or without information (the display screen 3 could still have the street address numbers on it somewhere and/or mixed in with a new background color or the logo).

The emergency/alert message 3B, importantly, could refer to an emergency service. For instance, if the police have been called, the message could be white-on-blue or blue-on-white with the word “help” or “police” or even the name of the situation (robbery, armed assailant, etc.). If the fire department has been called, the emergency/alert message 3B could be red on a white background or vice versa with the word “fire” or something even more particular, such as “baby upstairs” or “kitchen” to direct the firepersons to different areas of the house for focused lifesaving and/or fire suppressing. In the event an ambulance has been called, the colors could be different from the police and fire department colors and the message could even be as particular as information about the medical condition, for instance specifying where in the house the medical condition is taking place, what the condition probably is, whether the door is locked and instructions for where to find the key, etc.

In some of the preceding emergency/alert operational states the beacon 4 is also activated. Whether or not the beacon lights 5 conform to the emergency/alert situations, such as whether they should flash red for fire, is up to the manufacturer and/or, if the device is sold to be infinitely reconfigurable, it could be up to the household occupant. Whether the beacon should be used in non-emergency situations is up to the discretion of the household occupant or local regulations, but at the very least the beacon 4 should emit a great amount of light, either steadily or in a flashing or moving pattern, during police, fire, and ambulance dispatch situations. Again, in the latter scenarios it might be advantageous to still display the numerical string 3A somewhere on the display screen, either miniaturized and in the corner, or alternatingly with the emergency/alert message 3B, in order for the emergency personnel to be 100% confident that they are at the right property or residence.

Once an emergency situation has passed, the device 1 should be capable of being reset, such as manually via pushing or holding button 9 (FIG. 2) or using a remote control or an internet-enabled app, etc. Once reset, the display screen 3 should revert to the normal/typical display message 3A. While we are still referring to FIG. 2, it should be mentioned that button 9 needn't be the only interface that the device 1 has with the outside environment. Other ports and jacks 8 can be used to perform capabilities such as recharging the battery 10, reprogramming the electronics 12, syncing the device 1 up with another device or downloading new software, driving a loudspeaker or chime-emitting auxiliary device, etc.

Likewise, antennae (not shown) could be incorporated into some of the dead space within the hollow enclosure of the device 1 to establish low-energy radio transmissions (i.e. Bluetooth), or the like, with other wireless devices such as smartphones, Wi-Fi, or a LAN also a possibility. The ports or jacks 8, like was disclaimed for the push-button 9, do not need for any reason to be located in the area shown in FIG. 2, namely as incorporated in the left-side side wall 7. They could be located on the back or bottom of the device 1 or even in/on the bezel 2, such as for instance next to the beacon 4. Because all of these potential variations would be obvious to one of ordinary skill in the art, they will not be gone into further herein.

Moving on, in FIG. 5 the device 1 is shown with the bezel 2 still intact but the display screen 3 omitted in order to clearly illustrate the battery 10 and the internal electronic hardware or elements 12 that enable the functioning of the street address signage during all of the modes detailed herein. The purpose of this patent application is not to discuss electronic circuitry, battery types, printed circuit boards, etc. but to rely on these well-known items and their use when assembled and wired together appropriately to effectuate the household devices that the present invention is one of, and therefore, other than showing the innards (10 and 12) of the device 1 in the revealing layout in a generic assembly depicted in FIG. 5, no discussion will be attempted at detailing them or their interactions. Without going into further detail, it can at least be said that it is probably advantageous to have them all more or less affixed to the back wall 11 in order to immobilize them in their respective locations and in order to keep them away from the display screen 3. Most of the wiring within the device would also be best off as harnessed or bundled to the back wall 11 or the side walls 7 in various locations and using standard fixtures such as wire harnesses, clips, soldering-points, bands, etc.

In general, the electronic hardware elements 12 can comprise control circuitry, including Wi-Fi and/or cellular communication for IoT communication with other devices over wireless data infrastructure (cell towers) or other general (i.e. LAN, ISP) internet interfaces.

Further, the electronic hardware elements 12 comprise at least one unit for communicating with a smart control for controlling the display screen 3 to change the outputs 3A and 3B and/or to alternate between said. The battery 10 could be rechargeable or replaceable, and whether or not the battery 10 is part of the device 1, the electronic hardware elements 12 can include a hard electrical connection point to a household power supply, such as via a traditional power socket or being wired directly to household electrical power cables via a customizable junction. The device could also be connected and electrically powered via the doorbell jack that is typically near the front door of a home, in which case the device could be next to the doorbell, nearby, or incorporated with a modern doorbell assembly in it, such that the signage device, doorbell push-button, camera, etc. are all encased in the same housing.

It is contemplated that the present invention may be programmable via a user interface such as a home or laptop computer, a tablet, or smart phone, which may be local, online, or app based. Display screen images, videos, brilliance settings, etc. that can be configured variously and based on the desired use include, but are not limited to, connection type, numerical address, display screen font and color, and lighting color and frequency. In one or more embodiments, the device 1 may be cloud connected to emergency services or delivery/utility services (such as parcel delivery, United States Postal Service, propane or oil, septic, etc.), which will automatically activate the beacon 4 as needed during delivery window(s).

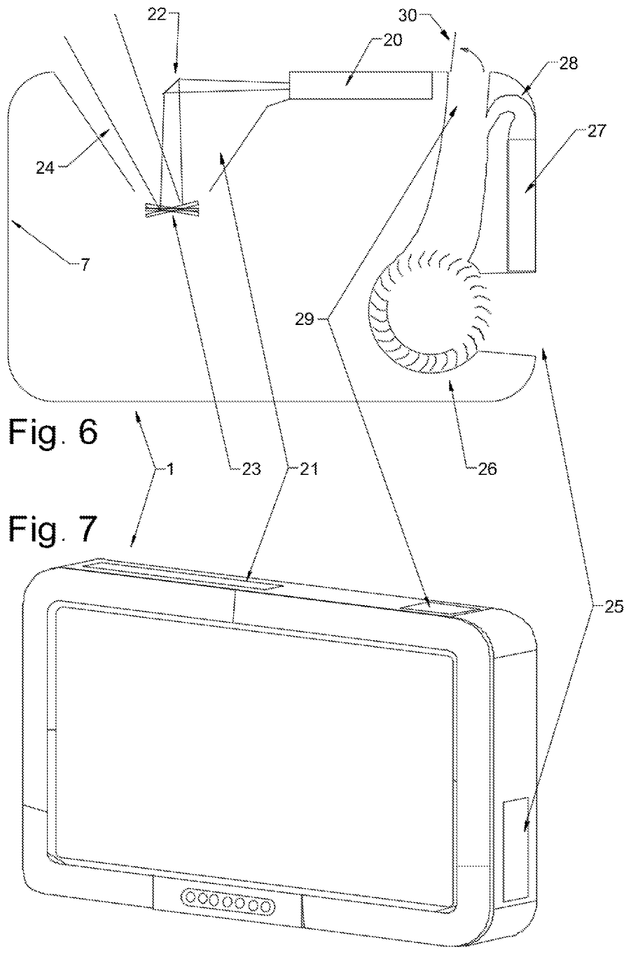

Turning now to FIGS. 6 and 7 which jointly illustrate a second embodiment of the address signage device 1. In FIG. 6 the bezel 2 and screen 3 have been removed altogether to show two visibility augmentation mechanisms that can be used together to augment the ability of persons to find the property or residence from several blocks or even miles away. A first augmentation mechanism is a smoke ejection device comprising a source of smoke 27, such as a modified “smoke bomb” or any other device that, when lit via an electrical spark or other means, creates a plume or stream of smoke that is ejected upwardly into a smoke duct 28 that connects the source of smoke 27 to a wind duct 29. A fan 26, such as a two-stage cross-flow fan, ingests ambient air from an intake duct 25 and feeds it into the wind duct 29 at elevated pressure and velocity with the overall objective of expelling air straight upward in a flow that is semi-entrained at first but which dissipates once it has reached a height several feet above the address signage device 1.

The smoke duct 28 allows free passage of the smoke from smoke source 27 because the smoke source 27 is encapsulated by surrounding structure such that the only way for smoke to escape is through the smoke duct 28, which is U-shaped in the preferred embodiment such that rain cannot fall into the smoke source 27. The smoke being fed from the smoke duct 28 is entrained by the air being exhausted from said fan 26 through said wind duct 29 such that it is carried upward to a point several feet, if not at least ten feet, before it is able to spread out. This creates a cloud of smoke above the device which should then continually rise and spread above the property or residence. When the smoke ejection device is not operable, the wind duct 29 is automatically closed by a door or flap 30 which is biased, such as by a spring, toward the horizontal, closed position.

The second augmentation mechanism is a sweeping light beam generation device consisting of a light source 20, embedded preferably in a removable or replaceable way, in a preferred embodiment, behind the bezel 2, which is accompanied by means for sweeping or twirling or fanning the light source above the device 1. Although various means for moving the light beam 24 around to draw attention to the property or residence could be useful, and all of these should be considered obvious to one of ordinary skill in the art, the Applicant has chosen the simplest device to portray this aspect in the drawings. A 45° angle mirror 22 reflects the light beam 24 down toward a movable mirror 23. The mirror can oscillate back and forth or spin on a shaft or twist, but in the simplest embodiment it is shown as sweeping, in FIG. 6, back and forth within a sector defined by the walls of a slit 21 that is located in the top of the device.

As the movable mirror 23 moves back and forth (or spins), the light beam 24 is made to sweep back and forth while still generally aimed upward toward the sky. The sky is being continuously plied with smoke from the smoke ejection device, and the resulting effect is a quasi-pyrotechnical display that manifests itself over the property or residence, and in such a way that even if the smoke wafts in one direction or another after being shot upward from the wind duct 29 by the power of the fan 26, the light beam 24 should at some point during its sweep contact some of the smoke, ensuring that the pyrotechnical display is visible from a considerable distance. In fact, if this system were provided with enough electrical power, the display could probably be seen from miles away, which might in fact be desired in certain situations, during both day and night visibility conditions.

The two visibility augmentation mechanisms should be used together but this is not necessary. Using only one of them would serve at least some purpose. Also, use of one or both of the visibility augmentation mechanisms could be performed simultaneously with the activation of the beacon 4 in a most preferred embodiment, but this should not be seen as limiting. They could be used at any time and for any purpose that might seem useful to a practitioner in the art.

FIG. 7 shows a front perspective view of said secondary embodiment of the heightened-visibility street address signage device 1, with said display screen 3 and bezel 2 (not labeled) in place, illustrating the external functional parts of said secondary embodiment. The visibility augmentation mechanisms' working parts are not shown, but the fan intake duct 25, the top of the wind duct 29, and the slit 21 (which serves as a space for the light beam 24 to move back and forth without being blocked by internal elements or the side walls 7) are shown to provide some understanding of where these could be and what shape they might take, although they could be anywhere and of any shape that serves the purpose at hand.

The light source 20 could be any typical light generation device such as a laser, bulb, diode, etc. and could be of a flashlight-type or other light-ray emitting style without departing from the scope of the invention as disclosed herein. Likewise, the smoke source 27 could be of any type of device, such as for example a solid or solidified chemical blend that is known to generate and exhaust a steady quantity of smoke in a single direction. The fan 26 could be of any type including axial-flow, radial-flow, and/or centrifugal fans or compressors.

The movable mirror 23 and 45° mirror 22 could be positioned in any combination of positions and moved through any movement or combination of movements that achieves a useful or appealing effect. Lenses and/or other mirrors could also be provided to bend the light beam so that it is projected somewhat horizontally or at various angles over a yard, in the event that the device 1 has an eave or roof over it. Also, the light source itself could move to create the movement of the light beam 24. A color-changing system could be incorporated between the light source 20 and the 45° mirror 22, for instance a rack or frame with sliding color panes that can selectively reciprocate into and out of the path of the light beam to change the color of the light beam reaching the 45° mirror 22, which thereby changes the color of the light that illuminates the smoke. The smoke could be gray smoke or white smoke or colored smoke. All of the foregoing options, as well as sundry choices and variations concerned with creating the visual effects along this line of thinking, should be considered as involving only routine skill in the art, now that the main concepts have been presented herein.

Having thus described the invention, what is claimed as new and desired to be secured by Letters Patent is:

1. A signage device comprising a housing configured to be attached to a structure that maintains said housing a distance above the ground, wherein said signage device further comprises:
at least one of an electrical power source and an electrical lead for connection to an electrical power source;
a display portion electrically connected to said at least one of an electrical power source and an electrical lead for connection to an electrical power source, to be electrically energized thereby, wherein said display portion comprises:
at least one display portion illumination mechanism;
electronic hardware configured to provide an electrical signal that controls an operational state of said at least one display portion illumination mechanism and thereby determines a visible characteristic of said display portion;
at least one of: a) a software or b) a wired connection or c) a wireless connection, configured to make the electronic hardware change said operational state of said at least one display portion illumination mechanism; and
wherein said visible characteristic of said display portion includes an array of numeric or alphanumeric content during a typical operational state;
wherein said signage device further includes a distress beacon, and said electronic hardware being operable to activate said distress beacon during a non-typical operational state.

2. The signage device of claim 1 wherein said distress beacon is integral with said display portion illumination mechanism.

3. The signage device of claim 2 wherein said distress beacon comprises a system for converting said display portion illumination mechanism to an alternative operational state, said alternative operational state including at least one of:
flashing part of or all of said display portion illumination mechanism;
increasing a brilliance of a light emitted from said display portion illumination mechanism;
changing a color of a light emitted from said display portion illumination mechanism; and
changing said numerical or alphanumerical content to include an emergency message instead of said alphanumerical content.

4. The signage device of claim 3 wherein said alternative operational state includes both changing a color of a light emitted from said display portion illumination mechanism and changing said numerical or alphanumerical content to include an emergency message instead of said alphanumerical content.

5. The signage device of claim 1 wherein said distress beacon comprises a secondary illumination mechanism activated separately from said display portion illumination mechanism.

6. The signage device of claim 5 wherein said secondary illumination mechanism is controllable by said electronic hardware to enter at least one secondary illumination mode, said at least one secondary illumination mode including at least one of:
flashing part of or all of said secondary illumination mechanism;
increasing a brilliance of a light emitted from said secondary illumination mechanism;
changing a color of a light emitted from said secondary illumination mechanism; and
moving or redirecting a beam or ray of a light emitted from said secondary illumination mechanism.

7. The signage device of claim 6 wherein said secondary illumination mode includes moving or redirecting a beam or ray of a light emitted from said secondary illumination mechanism, and wherein;
said secondary illumination mode further includes ejecting smoke from the signage device such that said beam or ray of light illuminates said smoke.

8. A method for controlling a signage device, said signage device comprising a housing configured to be attached to a structure that maintains said housing a distance above the ground, wherein said signage device further comprises:
at least one of an electrical power source and an electrical lead for connection to an electrical power source;
a display portion electrically connected to said at least one of an electrical power source and an electrical lead for connection to an electrical power source, to be electrically energized thereby, wherein said display portion comprises:
at least one display portion illumination mechanism;
at least one non-display portion illumination mechanism;
said method comprising:
firstly, presenting a numerical representation on said display portion illumination mechanism, said numerical representation including at least one digit and less than eight digits;
secondly, after presenting said numerical representation on said display portion illumination mechanism, emitting a high-intensity light from said non-display portion illumination mechanism.

9. The method for controlling a signage device of claim 8, wherein said emitting a high-intensity light from said non-display portion illumination mechanism comprises at least one of flashing said high-intensity light, moving said high-intensity light, and changing a color of said high-intensity light.

10. The method for controlling a signage device of claim 9 further including flashing or changing a color of said display portion illumination mechanism while performing said at least one of flashing said high-intensity light, moving said high-intensity light, and changing a color of said high-intensity light.

11. The method for controlling a signage device of claim 8 further including ejecting smoke upwardly from said signage device and illuminating said smoke with said high-intensity light being emitting from said non-display portion illumination mechanism.

12. Any of the electrical or mechanical devices or activities proposed herein.
